(19) United States
(12) Patent Application Publication
(10) Pub. No.: US 2007/0087088 A1
(43) Pub. Date: Apr. 19, 2007

(54) Method of packaging a product, a package, particularly containing coffee, and a packaging machine

(76) Inventors: Joachim Bellman, Hamburg (DE); Ian Howley, Darlington (GB); Jurgen Flieger, Berlin (DE)

Correspondence Address: FITCH EVEN TABIN & FLANNERY, 120 S. LASALLE STREET, SUITE 1600, CHICAGO, IL, 60603-3406, US

(21) Appl. No.: 11/536,366

(22) Filed: Sep. 28, 2006

(30) Foreign Application Priority Data
Sep. 28, 2005 (EP) 05021207.5

(51) Int. Cl. A23B 7/148

(52) U.S. Cl. 426/106

(57) ABSTRACT

A method of packaging a product, in particular coffee, includes the steps of sealing a first end of a packaging material so as to form a bag (12), filling the bag (12), sealing a filling opening of the bag (12) and arranging the bag so as to render the first end a top end of the package (10).

A package, in particular containing coffee, includes a bag (12) having a peelable seal (16) at a first end thereof, which is located at the top of the package (10). A packaging machine includes a device for forming a bag and a device for turning the bag or the final package about a horizontal axis after filling the bag and sealing a filling opening of the bag.

### TECHNICAL FIELD

The invention relates to a method of packaging a product, in particular coffee, a package, in particular containing coffee, and a packaging machine.

In the field of packaging food products, in particular coffee, several aspects, which involve specific requirements, have to be taken into account. Firstly, the coffee is to be packaged in a hermetic manner so as to keep its freshness and taste. Secondly, the packaging operation should be performed as economically as possible. Thirdly, it is desirable that the consumer will be able to open the package easily. Finally, both the closed and the opened package should exhibit an attractive outer appearance.

### BACKGROUND

EP 0298302 B1 discloses a vacuum pack for ground coffee, which can be wrapped in an outer wrapper. Such types of coffee packages are also available on the market, for example, for the applicant's “Jacobs Krönung” brand. DE 3833939 A1 and DE 3828847 A1 disclose similar vacuum packs.

### SUMMARY OF THE INVENTION

The invention provides a method of packaging a product, in particular coffee, which can efficiently produce a coffee package, which is both easy to open and has an attractive appearance. Moreover, an easy to open and attractive package, as well as a packaging machine for producing such a package, is provided.

The novel method of packaging a product includes the steps of sealing a first end of a packaging material so as to form a bag, filling the bag, sealing a filling opening of the bag and arranging the bag so as to render the first end a top end of the package. As will be apparent, the features, which define the novel method of packaging, are stated above. However, further steps will be required in order to produce the complete package. As regards the bag, the packaging material, from which the bag is made, can be any airtight and/or hermetic material, which can, particularly, be suitable to constitute a vacuum pack. Thus, the packaging material for forming the inner bag can be provided in the form of an endless tube, which is sealed at certain intervals so as to constitute separate bags. As an alternative, which is currently preferred, the bag can be formed from a web-like material, which is wrapped around a mandrel and in which a side seal and the above-mentioned first end seal are formed. Thus, one end remains open as a filling opening and coffee is filled into the bag at this open end. An outer wrapper can be wrapped around the bag either before or after filling the bag. Afterwards, an evacuating step can be carried out and the filling opening can be sealed thereafter.

According to the invention, the seal, which is formed as a first end seal on the bag, is, in the final package, the seal at the top end of the package. This can be taken from the fact that the material for forming the bag can be imprinted with, for example, product information. From the orientation of this imprinting, it can be seen where the top end of the package is located. Moreover, the bag can also be provided with an imprinting after filling and/or sealing the bag. The above aspect defining the top end of the package also applies in this case. As a further alternative, one or more labels can be applied to the material used for forming the bag, even before the bag is formed, or after sealing the filling opening of the bag, or in any intermediate stage as mentioned above.

Moreover, as will be described in more detail below, an outer wrapper can be wrapped around the bag. However, the bag alone can constitute the final package and can, in such a case, be called a “monobag”. As an alternative, as mentioned, one or more outer wrappers can be wrapped around the bag, so that the bag can be considered an inner bag. As the last mentioned embodiment is currently preferred, the term “inner bag” will be used hereinafter. However, it is to be understood that the bag does not necessarily have to be enclosed by an outer wrapper and embodiments lacking an outer wrapper are considered part of the invention. In any case, the seal of the inner bag, which is formed at a first end seal, particularly before filling the inner bag, is used as the top end seal. It is also to be understood that the top end seal does not necessarily have to be provided at the top end alone. Rather, the seal, which is used as an openable seal, can be provided additionally on one of the sides. The seal which is used as a seal to open the bag, can also be provided on one of the sides alone. Thus, the advantages of the invention described hereinafter, can also be used for these embodiments. In particular, the use of any seal, which is formed before filling the bag, as an openable seal, is considered part of the invention.

This provides the following advantages. As the top seal of the final package is formed as the first seal, its formation can be reliably controlled. In particular, this seal is formed before the product has been filled into the inner bag and before an evacuating step has been carried out. Thus, the packaging material, from which the inner bag is made, has merely been wrapped around, for example, a mandrel, and the material can be brought into a nearly perfect rectangular shape. In particular, the dimensions of those portions of the packaging material, which extend beyond the seal opposite that side where the product is filled into the bag, can efficiently be controlled. These portions can be formed as grippable flaps, which do not adhere to each other, so that they can be gripped and separated from each other so as to open the peelable seal. In this context, also the sealing force, with which the first seal is formed, can advantageously be controlled to provide a peelable seal.

In contrast, this has been found to be impossible for the second seal, which is formed after filling the product into the inner bag. This is because dust as well as a part of the product, such as ground coffee, which has been filled into the inner bag, can be present on the surfaces which are to be sealed to each other. Therefore, the second seal has to be formed sufficiently strong so as to ensure the necessary sealing force despite the presence of dust and, for example, particles of ground coffee. Such a sealing force can be too high to provide a peelable seal. Moreover, the second seal can, for example, be formed on sealing devices, which can, for example, be installed on an evacuation wheel. Because of the stage of the packaging process, in which this second seal is formed, i.e. on an evacuation wheel, and because this process takes a relatively long time, plural sealing devices have to be present in order to be compatible with the usual speed of the packaging process as a whole. Thus, temperature and sealing pressure of a plurality of sealing devices have to be controlled for the formation of the second end seal.

In contrast, in a preferred process, remarkably less sealing devices are necessary for the formation of the first end seal. Therefore, it is remarkably easier to control the required shape of the material forming the inner bag. Moreover, the temperature and pressure, which are necessary for, for example, forming a heat seal between two layers of the packaging material, which is used to form the inner bag, can more easily be controlled. It can also be mentioned that those changes of existing packaging machines or packaging lines, which are required to make the first end seal the top seal of the final package, are relatively minor. Thus, the novel method can be implemented in a cost efficient manner. Moreover, the second end seal, which is formed after filling the inner bag and evacuating the same, can now be the bottom seal of the inner bag. Thus, there is no need to provide openability to this seal. Furthermore, its outer appearance is not relevant for the outer appearance of the final package. Thus, the seal can be formed to provide sufficient sealing force, despite the presence of dust and particles of products to be packaged. As a consequence, the likelihood of air leaking into the package through this second end seal can be lowered.

Preferred embodiments of the novel method are described in the further claims.

As mentioned, one or more printed outer wrappers can be wrapped around the bag with an orientation of the printing, which renders the first end a top end of the package. The outer wrapper can be folded on the first end seal after the outer wrapper has been wrapped around the inner bag. After the second end of the inner bag has been sealed, the outer wrapper can be folded on this second end seal. Alternatively, or in addition thereto, a label can be applied on this side. The outer wrapper can be made of paper, plastic film or laminate, for example, consisting of paper and a plastic film or a suitably coated paper. In the currently preferred process, the individual outer wrapper is cut from a web and wrapped around the inner bag, after the first end seal and the side seal of the inner bag have been formed. When the outer wrapper is wrapped around the inner bag, the inner bag can still be on the mandrel, on which it has been formed. However, individual outer wrappers can already be supplied to the packaging machine. As an alternative, the individual outer wrappers can be cut from a web at any appropriate stage. In particular, the outer wrapper can be partially wrapped around the inner bag before this cutting takes place. In any case, the material of the outer wrapper can be chosen to provide the desired attractive appearance. Independent there from, the material of the inner bag can be specifically chosen so as to fulfil the requirements regarding airtightness, sealability and so on.

As already mentioned above, it provides advantages for an easy opening system of the final package, when at least one grippable flap is formed on the first end of the inner bag. In particular, two grippable flaps, which can have the same, or a different length and/or width, can be formed. These can be gripped and separated from each other, so as to open the seal at the first end.

The sealing force at this first end can advantageously be set so as to be peelable. This adds to the easy to open characteristics of the final package.

As regards the appearance of the final package, it is currently preferred to fold the outer wrapper on top of the first end of the inner bag. This leads to an attractive appearance of the package. However, a suitable, preferably peelable, label can also be applied to the top of the package.

It is, nevertheless, currently preferred to apply a label at least to the bottom of the package. In this context, it is evident that the invention can be seen in the idea to turn the package upside down by changing the orientation of the printing on the outer wrapper. However, the described label used to be the top label of the package and had, for example, to be peelable in order to provide easy opening of the outer wrapper. With the novel package, the label is applied to the bottom of the package and does not have to be used, i.e. removed for opening the package. Thus, there is no need to provide easy to open characteristics to this label. As these characteristics would be costly, an efficient production of an easy to open package is further supported.

As regards further process steps during the packaging of a product, it is, as mentioned above, advantageous if the filling opening is formed at a second end opposite the first end of the inner bag.

In this context, it is currently preferred to set the sealing force of the filling opening to be significantly higher than the sealing force of the first end seal. This helps to minimize the likelihood of air leaking into the package despite the presence of dust and/or particles of the packaged product, such as coffee powder.

In currently used packaging lines, the novel package would, because of the change of orientation, be present “upside down” at the end of the line. However, in order to provide advantages with regard to the product presentation later on, it is currently preferred to turn the package about a substantially horizontal axis after the step of sealing the filling opening. When the outer wrapper has not yet been applied, also the inner bag alone can be turned about a horizontal axis.

In view of the desired easy to open characteristics of the package as a whole, it is currently preferred to apply a tear tape to the outer wrapper. Thus, the outer wrapper can easily be opened by tearing the tear tape and, possibly, remove a part of the outer wrapper from the package. This advantageously serves to expose the first end seal of the inner bag. As regards the application of a tear tape to the outer wrapper, reference is made to the Applicant's EP 05016623 which is incorporated herein by reference with regard to any features related to the application of tear tapes to the outer wrapper. Thus, the invention can also be realized by a combination of one or more of the above-mentioned features and the application of tear tapes to the outer wrapper. Despite the above-referenced application, the one or more tear tapes can be applied at an angle to the machine direction or substantially in the machine direction.

The final package described herein, which can particularly contain coffee, includes a bag having a peelable seal at a first end thereof, which is located at the top of the package. As is apparent from the above, such a package, which is beneficial for the consumer, is easy to open and can efficiently be produced with the method described above.

The preferred embodiments of the novel package substantially correspond to the above-mentioned preferred method steps.

Finally, the invention provides a packaging machine which includes a device for forming a bag and a device for turning the package about a horizontal axis after filling the bag and sealing a filling opening of the bag. This device for turning the package can either turn the bag, after the second end has been sealed, and before the optional outer wrapper has been applied. Alternatively, the final package with the outer wrapper wrapped around the bag, can be turned.

Thus, the packaging machine can include a device for wrapping one or more outer wrappers around the bag.

Corresponding to the above-described preferred embodiments, the packaging machine according to the invention can include a device for applying tear tapes to the outer wrapper. Also in this context, the disclosure of above-mentioned EP 05016623 of the Applicant is incorporated by reference.

### BRIEF DESCRIPTION OF THE DRAWINGS

The invention is described hereinafter with reference to drawings, in which:

FIG. 1 shows a perspective view of the top of the inventive package before opening the inner bag;

FIG. 2 shows a perspective view of the top of the inventive package after opening.

### DESCRIPTION OF THE PREFERRED EMBODIMENT OF THE INVENTION

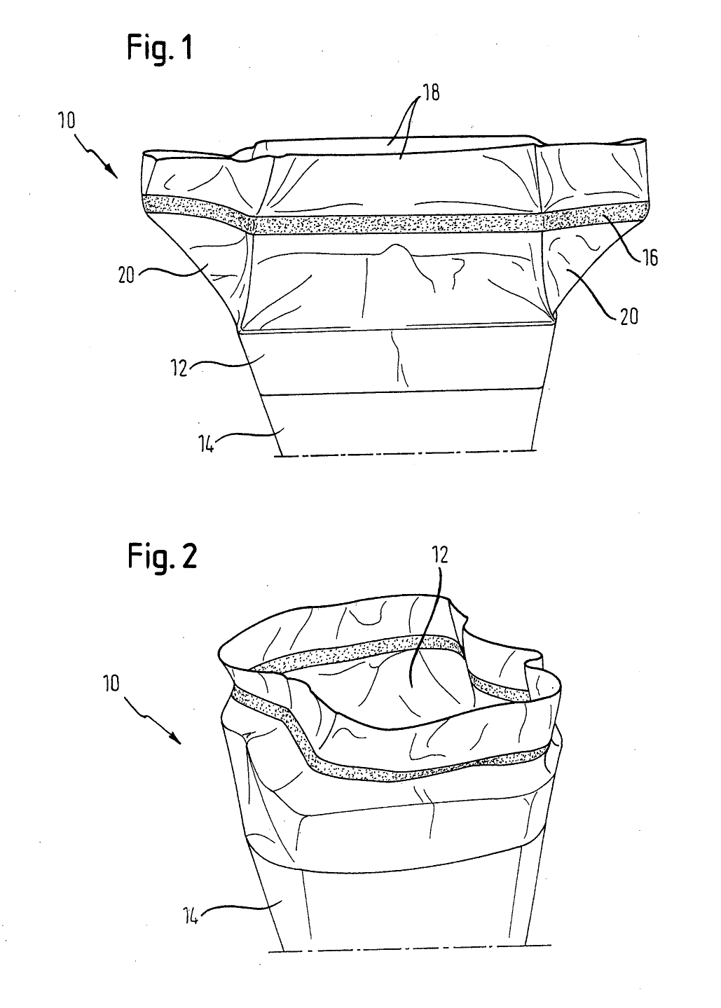

As can be taken from FIG. 1, the preferred embodiment of the novel package 10 is a coffee package, which essentially has a cuboid-shape. The cuboid is defined by the inner bag 12, around which an outer wrapper 14 is wrapped. In the situation of FIG. 1, which shows the package 10 after a first opening step, a part of the outer wrapper 14 has already been removed. At the top of the package 10, a seal 16 is present. The packaging material, which forms the inner bag 12, extends beyond the seal 16, so as to form grippable flaps 18. The outer wrapper can contain imprinted product information such as “Krönung”. For the embodiment shown, it can be noted that the outer wrapper can, for example, contain a tear tape (not shown), which has been torn so as to remove the upper part of the outer wrapper and expose the corresponding part of the inner bag 12. Subsequently, during opening, the downwardly and laterally folded, grippable flaps 18 and side tabs 20 have been lifted. Finally, the grippable flaps can be separated from each other, gripped separately and torn apart, so as to open the peelable seal 16.

FIG. 2 shows the opened state, which can, particularly, be reached without using scissors or the like. In FIG. 2 a situation is shown, in which the top part of the outer wrapper 14 has not been removed, but it has merely been unfolded. This serves to keep the entire branding and product information provided on the outer wrapper 14. However, also with the embodiment of FIG. 1, when only the top part of the outer wrapper 14 is removed, the main product information can be kept, also in the opened state.

1. A method of packaging a product, in particular coffee, including the steps of sealing a first end of a packaging material so as to form a bag (12), filling the bag (12), sealing a filling opening of the bag (12) and arranging the bag so as to render the first end a top end of the package (10).

2. The method of claim 1, wherein at least one printed outer wrapper (14) is wrapped around the bag (12) with an orientation of the printing which renders the first end a top end of the package (10).

3. The method in accordance with claim 1 or 2, wherein at least one grippable flap (18) is formed at the first end.

4. The method in accordance with any of the preceding claims, wherein a sealing force at the first end is set so as to be peelable.

5. The method in accordance with any of claims 2 to 4, wherein the outer wrapper (14) is folded on top of the first end of the inner bag (12).

6. The method in accordance with any of the preceding claims, wherein a label is applied at least to the bottom of the package (10).

7. The method in accordance with any of the preceding claims, wherein the filling opening is formed at a second end opposite the first end.

8. The method in accordance with claim 6, wherein the sealing force of the filling opening is set significantly higher than the sealing force of the first end.

9. The method in accordance with any of the preceding claims, wherein the bag or the final package is turned about a substantially horizontal axis after the step of sealing the filling opening of the bag.

10. The method in accordance with any of the preceding claims 2 to 9, wherein a tear tape is applied to the outer wrapper (14).

11. A package, in particular containing coffee, including a bag (12) having a peelable seal (16) at a first end thereof, which is located at the top of the package (10).

12. The package in accordance with claim 11, further including at least one printed outer wrapper (14) wrapped around the bag (12).

13. The package in accordance with claim 11 or 12, wherein the first end includes at least one grippable flap (18).

14. The package in accordance with claim 12 or 13, wherein the outer wrapper (14) is folded on top of the first end of the inner bag (12).

15. The package in accordance with any of claim 11 to 14, wherein a label is applied at least to the bottom of the package (10).

16. The package in accordance with claim 11 to 15, wherein the second end of the bag (12), opposite the first end, is sealed, and a sealing force at the second end is significantly higher that the sealing force at the first end.

17. The package in accordance with any of claims 12 to 16, wherein the outer wrapper (14) includes at least one tear tape.

18. A packaging machine including a device for forming a bag and a device for turning the bag or the final package about a horizontal axis after filling the bag and sealing a filling opening of the inner bag.

19. The packaging machine in accordance with claim 18, further including a device for wrapping at least one outer wrapper around the bag.

20. The packaging machine in accordance with claim 18 or 19, wherein the packaging machine includes a device for applying tear tapes to the outer wrapper.
